(19) United States
(12) Patent Application Publication
(10) Pub. No.: US 2023/0291553 A1
(43) Pub. Date: Sep. 14, 2023

(54) CYPHER SYSTEM, METHOD AND PROGRAM

(71) Applicant: NIPPON TELEGRAPH AND TELEPHONE CORPORATION, Tokyo (JP)

(72) Inventor: Junichi TOMIDA, Tokyo (JP)

(21) Appl. No.: 18/041,103

(22) PCT Filed: Sep. 8, 2020
(86) PCT No.: PCT/JP2020/033946

§ 371 Date: Feb. 9, 2023

(51) Int. Cl. H04L 9/08; H04L 9/06; H04L 9/30

(52) U.S. Cl. CPC H04L 9/0861; H04L 9/0618; H04L 9/3006; H04L 9/0822

(57) ABSTRACT

An encryption system according to an embodiment is an encryption system for performing encryption and decryption using functional encryption using a quadratic function having n (where n is a predetermined integer of 2 or more) arguments, which includes a setup unit configured to generate a master secret key of the functional encryption using a master secret key of function concealed inner product functional encryption composed of pairing calculation and a master secret key of multi-input function concealed inner product functional encryption obtained by extending the function concealed inner product functional encryption to multi-inputs, an encryption unit configured to generate n pieces of ciphertext obtained by encrypting n pieces of data using the master secret key of the function concealed inner product functional encryption, the master secret key of the multi-input function concealed inner product functional encryption, and the master secret key of the functional encryption, a key generation unit configured to generate a secret key for decrypting the n pieces of ciphertext using data representing the quadratic function and the secret key of the multi-input function concealed inner product functional encryption, and a decryption unit configured to decrypt the n pieces of ciphertext using the secret key generated by the key generation unit to generate a value of the quadratic function for the n pieces of data.

### TECHNICAL FIELD

The present invention relates to an encryption system, method and program.

### BACKGROUND ART

Multi-input functional encryption is a cryptographic scheme capable of decrypting only function values having a plurality of pieces of data as an input from ciphertext of the plurality of pieces of data, and has one characteristic that the content of the original data other than the function values cannot be leaked in this case. More specifically, in a case in which ciphertext of n pieces of data x₁, . . . , xₙ are CT₁, . . . , CTₙ, a function having n arguments is f, and a secret key corresponding to the function f is SK, only a function value f(x₁, . . . , xₙ) is obtained when CT₁, . . . , CTₙ are decrypted with the secret key SK, and no other information on x₁, . . . , xₙ is leaked.

Currently known composition methods for multi-input functional encryption are roughly configured as two types. A first method is a method that is capable of handling a function of a general circuit class and is so heavy that implementation is substantially impossible, and whose safety is unclear (for example, NPL 1), and a second method is a method that is capable of handling only a specific function called a primary function and can be implemented relatively lightly, and whose safety is reliable (for example, NPL 2).

### CITATION LIST

### Non Patent Literature

[NPL 1] S. Goldwasser, S. D. Gordon, V. Goyal, A. Jain, J. Katz, F.-H. Liu, A. Sahai, E. Shi, and H.-S. Zhou. Multi-input functional encryption. In P. Q. Nguyen and E. Oswald, editors, EUROCRYPT 2014, volume 8441 of LNCS, pages 578-602. Springer, Heidelberg, May 2014.
[NPL 2] M. Abdalla, R. Gay, M. Raykova, and H. Wee. Multi-input inner-product functional encryption from pairings. In J. Coron and J. B. Nielsen, editors, EUROCRYPT 2017, Part I, volume 10210 of LNCS, pages 601-626. Springer, Heidelberg, April/May 2017.

### SUMMARY OF INVENTION

### Technical Problem

As described above, at present, the only multi-input functional encryptions known that can be realized with a relatively light implementation are those capable of calculating a primary function. However, for example, because a quadratic function needs to be calculated when it is desired to calculate a variance using a plurality of pieces of data, the first very heavy multi-input functional encryption described above needs to be used in such a case.

An embodiment of the present invention has been made in view of the above points, and an object thereof is to realize an efficient multi-input functional encryption using a quadratic function.

### Solution to Problem

In order to achieve the above object, an encryption system according to an embodiment is an encryption system for performing encryption and decryption using functional encryption using a quadratic function having n (where n is a predetermined integer of 2 or more) arguments, which includes a setup unit configured to generate a master secret key of the functional encryption using a master secret key of function concealed inner product functional encryption composed of pairing calculation and a master secret key of multi-input function concealed inner product functional encryption obtained by extending the function concealed inner product functional encryption to multi-inputs, an encryption unit configured to generate n pieces of ciphertext obtained by encrypting n pieces of data using the master secret key of the function concealed inner product functional encryption, the master secret key of the multi-input function concealed inner product functional encryption, and the master secret key of the functional encryption, a key generation unit configured to generate a secret key for decrypting the n pieces of ciphertext using data representing the quadratic function and the secret key of the multi-input function concealed inner product functional encryption, and a decryption unit configured to decrypt the n pieces of ciphertext using the secret key generated by the key generation unit to generate a value of the quadratic function for the n pieces of data.

### Advantageous Effects of Invention

It is possible to realize efficient multi-input functional encryption using a quadratic function.

### BRIEF DESCRIPTION OF DRAWINGS

FIG. 1 is a diagram illustrating an example of an overall configuration of an encryption system according to the present embodiment.

FIG. 2 is a flowchart illustrating an example of a flow of setup processing according to the present embodiment.

FIG. 3 is a flowchart illustrating an example of a flow of encryption processing according to the present embodiment.

FIG. 4 is a flowchart illustrating an example of a flow of key generation processing according to the present embodiment.

FIG. 5 is a flowchart illustrating an example of a flow of decryption processing according to the present embodiment.

FIG. 6 is a diagram illustrating an example of a computer hardware configuration.

### DESCRIPTION OF EMBODIMENTS

Hereinafter, an embodiment of the present invention will be described. In the present embodiment, an encryption system 1 that realizes efficient multi-input functional encryption using a quadratic function will be described.

<Theoretical Configuration of Efficient Multi-Input Functional Encryption Using Quadratic Function>

First, a theoretical configuration of the multi-input functional encryption used by the encryption system 1 according to the present embodiment will be described.

«Preparation»

p is a prime number, Z is an integer ring, and a quotient ring Z/pZ is expressed as Zₚ (where Z is expressed in white letters to be exact hereinafter, similarly, Z in the text of the specification is represented by white characters to be exact). Further, an operation of randomly selecting an element from Zₚ is expressed as z←Zₚ. An output of a certain algorithm Alg being y is expressed as y←Alg.

A known function concealed inner product functional encryption composed of pairing is iFE=(iSetup, iEnc, iKeyGen, iDec), and multi-input function concealed inner product functional encryption that is a multi-input version thereof is miFE=(miSetup, miEnc, miKeyGen, miDec). As the pairing constituting such function concealed inner product functional encryption, pairing defined by using a known bilinear type group may be used, or pairing defined by using a bilinear type group generated by a setup algorithm Setup, which will be described below, may be used.

As a function concealed inner product functional encryption iFE=(iSetup, iEnc, iKeyGen, iDec) composed of pairing, for example, function concealed inner product functional encryption proposed in reference 1 “J. Tomida, M. Abe, and T. Okamoto. Efficient functional encryption for inner-product values with full-hiding security. In M. Bishop and A. C. A. Nascimento, editors, ISC 2016, volume 9866 of LNCS, pages 408-425. Springer, Heidelberg, September 2016.” may be used.

Further, as a multi-input function concealed inner product functional encryption miFE=(miSetup, miEnc, miKeyGen, miDec) composed of pairing, for example, multi-input function concealed inner product functional encryption proposed in Reference 2 “P. Datta, T. Okamoto, and J. Tomida. Full-hiding (unbounded) multi-input inner product functional encryption from the k-linear assumption. In M. Abdalla and R. Da-hab, editors, PKC 2018, Part II, volume 10770 of LNCS, pages 245-277. Springer, Heidelberg, March 2018” may be used.

«Specific Configuration of Each Algorithm that Realizes Multi-Input Functional Encryption»

It is assumed that m is a dimension of a vector at the time of encryption, and n is the number of inputs of the function (number of arguments). In this case, the multi-input functional encryption according to the present embodiment includes four algorithms, that is, a setup algorithm Setup, an encryption algorithm Enc, a key generation algorithm KeyGen, and a decryption algorithm Dec.

Setup Algorithm Setup

This algorithm generates and outputs a master secret key MSK as follows.

iMSK₁,iMSK₂←iSetup

miMSK←miSetup

u_{i,j},ũ_{i,j},v_{i,j},\tilde{v}_{i,j},w_{i,j,k,l}← [symbol] ₚ

MSK:=(iMSK₁,iMSK₂,miMSK,

{u_{i,j},ũ_{i,j},v_{i,j},\tilde{v}_{i,j}}_{i∈[n],j∈[m]},{ [symbol] [symbol] _{∈[m]})

However, iMSK₁ is a master secret key of iFE having an input number n in which the number of dimensions is 2n+3+mn, and iMSK₂ is a master secret key of iFE having an input number n in which the number of dimensions is 1. Further, miMSK is a master secret key of miFE having an input number n, in which the number of dimensions is 2.

Encryption Algorithm Enc (MSK, i, x)

This algorithm generates and outputs a ciphertext CTᵢ corresponding to an input i of x∈Z^{m} as follows.

s,\tilde{s},r,t,L← [symbol] ₚ,

L:=(0²⁽ⁱ⁻¹⁾,1,L,0²⁽ⁿ⁻ⁱ⁾),\tilde{L}:=(0²⁽ⁱ⁻¹⁾,L,−1,0²⁽ⁿ⁻ⁱ⁾)

bⱼ:(L,xⱼ,sw_{1,1,i,j}, . . . ,ww_{m,n,i,j},uᵢⱼ,tv_{i,j}),\tilde{b}ⱼ:=(\tilde{L},xⱼ,\tilde{s}e_{i,j},rũ_{i,j}\tilde{v}_{i,j})

f:=(r,t)

iCT_{i,j}←iEnc(iMSK₁,bⱼ),iSK_{i,j}←iKeyGen(iMSK₁,bⱼ)

iCTᵢ←iEnc(iMSK₂,s),iSKᵢοiKeyGen(iMSK₂,\tilde{s})

miCTᵢ←miEnc(miMSK,i,f)

CTᵢ:=({iCT_{i,j},iSK_{i,j}}_{j∈[m]},iCTᵢ,iSKᵢ,miCTᵢ) [Math. 2]

Here, x=(x₁, . . . , xₘ). Further, e_{i,j}∈Zₚ^{mn} is a vector in which a (i, j) component is 1 and other components are 0.

Key Generation Algorithm KeyGen (MSK, c)

This algorithm is as follows and generates and outputs the secret key SK corresponding to:

$$c = {\{ {c}_{i , j , k , ℓ} \}}_{i , k ∈ [ n ] , j , ℓ , ∈ [ m ]} ∈ {ℤ}^{{( mn )}^{2}} \qquad [ Math . 3 ]$$

$${\tilde{f}}_{i} := ( {\sum }_{k ∈ [ n ] , j , ℓ ∈ [ m ]} {c}_{i , j , k , ℓ} {u}_{k , ℓ} {\tilde{u}}_{i , j} , {\sum }_{k ∈ [ n ] , j , ℓ ∈ [ m ]} {c}_{k , ℓ , i , j} {υ}_{i , j} {\tilde{υ}}_{k , ℓ} ) \qquad [ Math . 4 ]$$

$$miSK ← miKeyGen ( miMSK , ( {\tilde{f}}_{1} , … , {\tilde{f}}_{n} ) )$$

$${h}_{i , k} := {\sum }_{j , ℓ ∈ [ m ]} {c}_{i , j , k , ℓ} {w}_{i , j , k , ℓ}$$

$$SK := ( c , {\{ {h}_{i , k} \}}_{i , k ∈ [ n ]} , miSK )$$

Here, the above c is a vector expressing the following quadratic function f.

f(X₁, . . . ,Xₙ):=<c,X(x)X>

Here, (x) is a Kronecker product, X₁, . . . , Xₙ∈Zₚ^{m}, X^{τ}=(X₁^{τ}∥ . . . ∥Xₙ^{τ}), τ is a transpose, and ∥ is a symbol representing concatenation. That is, c is a vector representing a quadratic function defined by an inner product with a value obtained naturally vectorizing X(x)X.

Decryption Algorithm Dec (CT₁, . . . , CTₙ, SK)

This algorithm generates and outputs a decryption result d as follows.

$${z}_{1} := {\sum }_{i , k ∈ [ n ] , j , ℓ ∈ [ m ]} {c}_{i , j , k , ℓ} iDec ( {iCT}_{i , j} , {iSK}_{k , ℓ} ) \qquad [ Math . 5 ]$$

$${z}_{2} := {\sum }_{i , k ∈ [ n ]} {h}_{i , k} iDec ( {iCT}_{i} , {iSK}_{k} )$$

$${z}_{3} := miDec ( {miCT}_{1} , … , {miCT}_{n} , miSK )$$

$$d := {z}_{1} - {z}_{2} - {z}_{3}$$

<Overall Configuration of Encryption System 1>

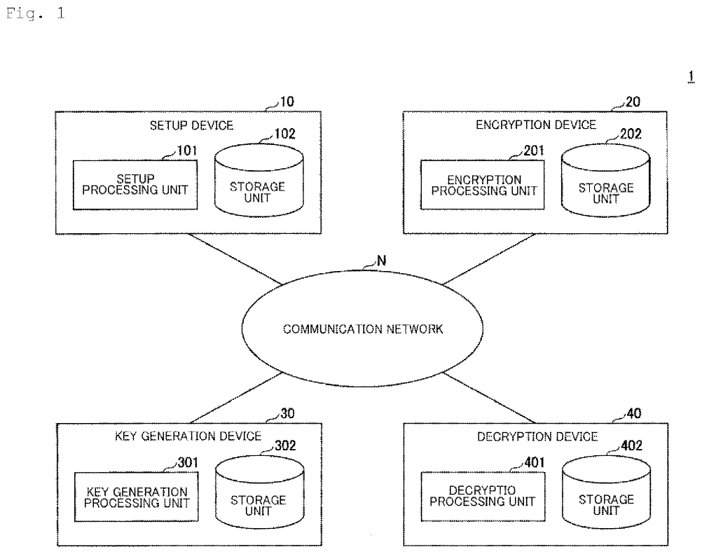

Next, an overall configuration of the encryption system 1 according to the present embodiment will be described with reference to FIG. 1. FIG. 1 is a diagram illustrating an example of an overall configuration of the encryption system 1 according to the present embodiment.

As illustrated in FIG. 1, the encryption system 1 according to the present embodiment includes a setup device 10, an encryption device 20, a key generation device 30, and a decryption device 40. Further, each of these devices is communicatively connected via a communication network N.

The setup device 10 is a computer or a computer system that executes the setup algorithm Setup. The setup device 10 includes a setup processing unit 101 that executes the setup algorithm Setup, and a storage unit 102 that stores various pieces of data used for execution of the setup algorithm Setup, an output result thereof, and the like.

The encryption device 20 is a computer or a computer system that executes an encryption algorithm Enc (MSK, i, x). The encryption device 20 includes an encryption processing unit 201 that executes the encryption algorithm Enc (MSK, i, x), and a storage unit 202 that stores various pieces of data used for execution of the encryption algorithm Enc (MSK, i, x), an output result thereof, and the like.

The key generation device 30 is a computer or a computer system that executes the key generation algorithm KeyGen (MSK, c). The key generation device 30 includes a key generation processing unit 301 that executes the key generation algorithm KeyGen (MSK, c), and a storage unit 302 that stores various pieces of data used for execution of the key generation algorithm KeyGen (MSK, c) or an output result thereof.

The decryption device 40 is a computer or a computer system that executes the decryption algorithm Dec (CT₁, . . . , CTₙ, SK). The decryption device 40 includes a decryption processing unit 401 that executes the decryption algorithm Dec (CT₁, . . . , CTₙ, SK), and a storage unit 402 that stores various pieces of data used for execution of the decryption algorithm Dec (CT₁, . . . , CTₙ, SK) or an output result thereof.

An overall configuration of the encryption system 1 illustrated in FIG. 1 is an example, and the encryption system 1 may have another configuration. For example, the setup device 10 and the key generation device 30 may be integrally configured.

<Flow of Processing>

Next, a flow of various processing executed by the encryption system 1 according to the present embodiment will be described.

«Setup Processing»

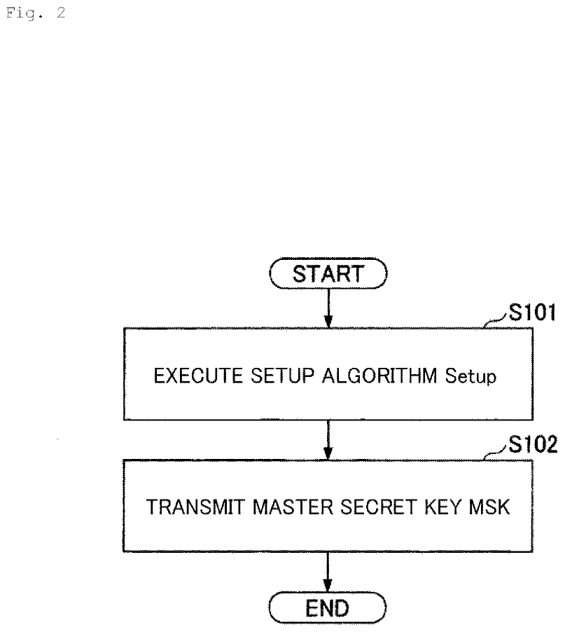

First, a flow of the setup processing according to the present embodiment will be described with reference to FIG. 2. FIG. 2 is a flowchart illustrating an example of a flow of the setup processing according to the present embodiment.

The setup processing unit 101 of the setup device 10 executes the setup algorithm Setup to generate and output the master secret key MSK (step S101). When the setup algorithm Setput is executed, for example, a security parameter 1^{λ} or the like is input.

The setup processing unit 101 of the setup device 10 transmits the master secret key MSK generated and output in step S101 above to the encryption device 20 and the key generation device 30 (step S102). The setup device 10 may transmit the master secret key MSK to the encryption device 20 and the key generation device 30 using any secure method.

«Encryption Processing»

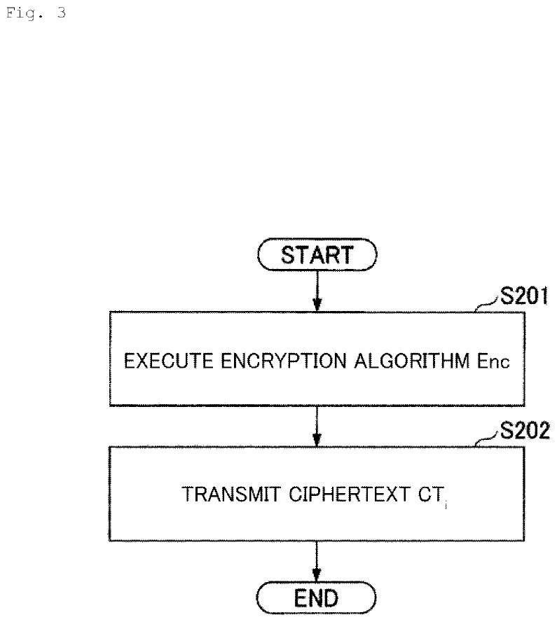

Next, a flow of encryption processing according to the present embodiment will be described with reference to FIG. 3. FIG. 3 is a flowchart illustrating an example of a flow of the encryption processing according to the present embodiment.

The encryption processing unit 201 of the encryption device 20 executes the encryption algorithm Enc (MSK, i, x) to generate and output the ciphertext CTᵢ corresponding to the input i of x∈Z^{m} (step S201). It is assumed that the data x that is an encryption target or the master secret key MSK is stored in the storage unit 202 of the encryption device 20.

The encryption processing unit 201 of the encryption device 20 transmits the ciphertext CTᵢ generated and output in step S201 above to the decryption device 40 (step S202).

«Key Generation Processing»

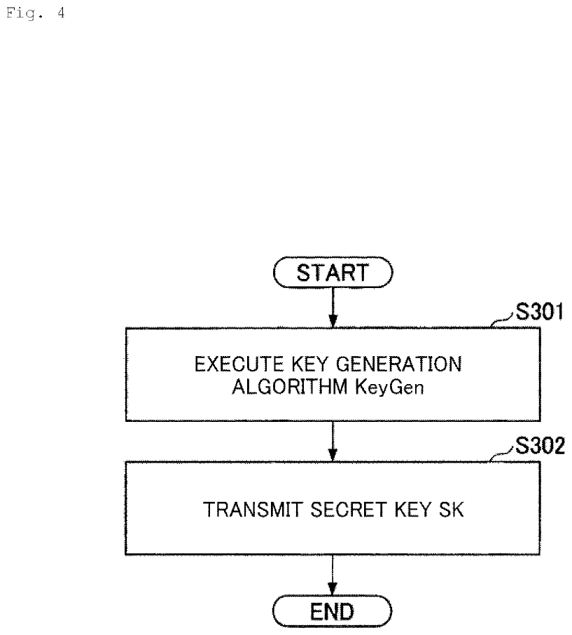

Next, a flow of the key generation processing according to the present embodiment will be described with reference to FIG. 4. FIG. 4 is a flowchart illustrating an example of a flow of the key generation processing according to the present embodiment.

The key generation processing unit 301 of the key generation device 30 executes the key generation algorithm KeyGen (MSK, c) to generate and output the secret key SK corresponding to c (step S301). It is assumed that data c representing the quadratic function or the master secret key MSK are stored in the storage unit 302 of the key generation device 30.

The key generation processing unit 301 of the key generation device 30 transmits the secret key SK generated and output in step S301 above to the decryption device 40 (step S302). The key generation device 30 may transmit the secret key SK to the decryption device 40 using any secure method.

«Decryption Processing»

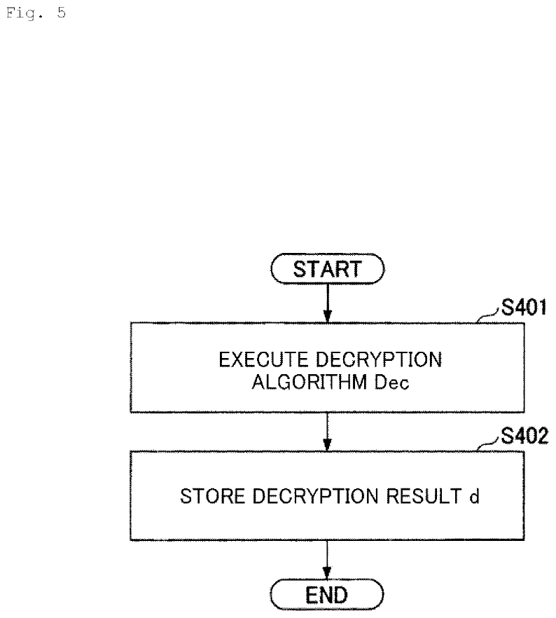

Next, a flow of the decryption processing according to the present embodiment will be described with reference to FIG. 5. FIG. 5 is a flowchart illustrating an example of a flow of the decryption processing according to the present embodiment.

The decryption processing unit 401 of the decryption device 40 executes the decryption algorithm Dec (CT₁, . . . , CTₙ, SK) to generate and output the decryption result d (step S401).

The decryption processing unit 401 of the decryption device 40 stores a composite result d generated and output in step S401 above in the storage unit 402 (step S402).

<Hardware Configuration>

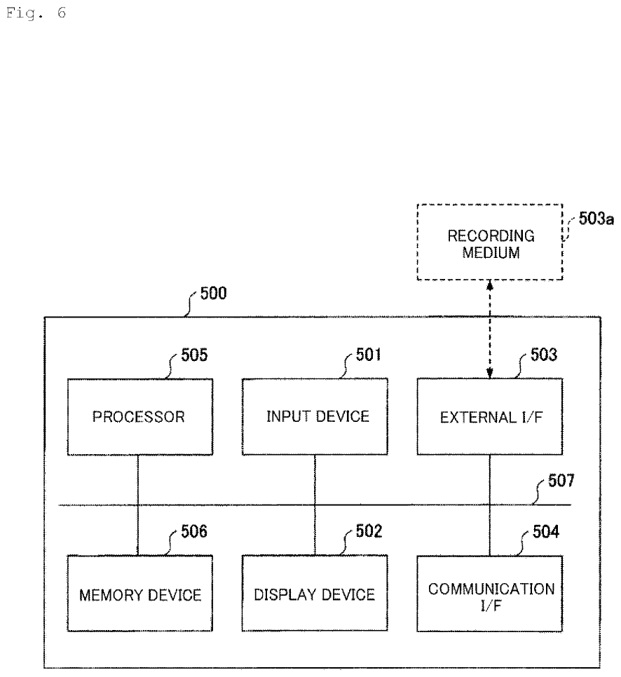

Next, hardware configurations of the setup device 10, the encryption device 20, the key generation device 30, and the decryption device 40 included in the encryption system 1 according to the present embodiment will be described. The hardware configuration of these devices can be realized, for example, by a hardware configuration of a computer 500 illustrated in FIG. 6. FIG. 6 is a diagram illustrating an example of the hardware configuration of the computer 500.

The computer 500 illustrated in FIG. 6 includes an input device 501, a display device 502, an external I/F 503, a communication I/F 504, a processor 505, and a memory device 506 as hardware. These pieces of hardware are communicatively connected via a bus 507.

The input device 501 is, for example, a keyboard, a mouse, or a touch panel. The display device 502 is, for example, a display or the like. The computer 500 may not include, for example, at least one of the input device 501 and the display device 502.

The external I/F 503 is an interface with an external device such as a recording medium 503a. Examples of the recording medium 503a include a flexible disk, a compact disc (CD), a digital versatile disk (DVD), a secure digital memory card (SD memory card), and a Universal Serial Bus (USB) memory card.

The communication I/F 504 is an interface for connecting the computer 500 to the communication network N. The processor 505 is, for example, a calculation device such as a central processing unit (CPU). The memory device 506 is, for example, any of various storage devices such as a hard disk drive (HDD), a solid state drive (SSD), a random access memory (RAM), a read only memory (ROM), and a flash memory.

The setup device 10, the encryption device 20, the key generation device 30, and the decryption device 40 according to the present embodiment can realize the various processing described above by having the hardware configuration of the computer 500 illustrated in FIG. 6. The hardware configuration illustrated in FIG. 6 is an example, and the computer 500 may have another hardware configuration. For example, the computer 500 may include a plurality of processors 505 or may include a plurality of memory devices 506.

### CONCLUSION

As described above, the encryption system 1 according to the present embodiment realizes encryption and decryption through multi-input functional encryption of a quadratic function using the function concealed inner product functional encryption iFE that can be composed of pairing and the multi-input function concealed inner product functional encryption miFE that is a multi-input version thereof (that is, obtained by an extension to multi-input) as components. Because the functional concealed inner product functional encryption itself can be composed of pairing calculation that can be performed at high speed, it is possible to also eventually calculate the multi-input functional encryption using these functional concealed inner product functional encryptions as components at high speed. Therefore, the encryption system 1 according to the present embodiment can realize efficient multi-input functional encryption using a quadratic function.

Therefore, using the encryption system 1 according to the present embodiment, it is possible to calculate a quadratic function value at an extremely high speed as compared with the related art without leaking information of other original data from a plurality of ciphertext. As an application example, for example, in a situation in which there are persons who want to perform statistical calculation requiring a quadratic function such as a variance using a plurality of pieces of databases, while an owner of the databases may disclose statistical values, but does not want disclose original data, it is possible to calculate only the statistical values at high speed without leaking the information of the original data using the encryption system 1 according to the present embodiment.

The present invention is not limited to the specifically disclosed embodiment, and various modifications or changes, combinations with known technologies, and the like can be made without departing from the description of the claims.

### REFERENCE SIGNS LIST

1 Encryption system
10 Setup device
20 Encryption device
30 Key generation device
40 Decryption device
101 Setup processing unit
102 Storage unit
201 Encryption processing unit
202 Storage unit
301 Key generation processing unit
302 Storage unit
401 Decryption processing unit
402 Storage unit
N Communication network

1. An encryption system for performing encryption and decryption using functional encryption using a quadratic function having n (where n is a predetermined integer of 2 or more) arguments, the encryption system comprising:
a processor; and
a memory storing program instructions that cause the processor to:
generate a master secret key of the functional encryption using a master secret key of function concealed inner product functional encryption composed of pairing calculation and a master secret key of multi-input function concealed inner product functional encryption obtained by extending the function concealed inner product functional encryption to multi-inputs;
generate n pieces of ciphertext obtained by encrypting n pieces of data using the master secret key of the function concealed inner product functional encryption, the master secret key of the multi-input function concealed inner product functional encryption, and the master secret key of the functional encryption;
generate a secret key for decrypting the n pieces of ciphertext using data representing the quadratic function and the secret key of the multi-input function concealed inner product functional encryption; and
decrypt the n pieces of ciphertext using the generated secret key to generate a value of the quadratic function for the n pieces of data.

2. The encryption system according to claim 1, wherein the processor generates a bilinear group and uses a master secret key of a function concealed inner product functional encryption composed through pairing calculation defined by the generated bilinear group, and the master secret key of the multi-input function concealed inner product functional encryption.

3. The encryption system according to claim 1, wherein the processor performs secret key generation and encryption of the function concealed inner product functional encryption and encryption of the multi-input function concealed inner product functional encryption using each of the n pieces of data to generate each of the n pieces of ciphertext.

4. The encryption system according to claim 1, wherein the processor generates the secret key of the multi-input function concealed inner product functional encryption using the data representing the quadratic function and the master secret key of the multi-input function concealed inner product functional encryption, and generates a secret key for decrypting the n pieces of ciphertext using the generated secret key and the data representing the quadratic function.

5. The encryption system according to claim 1, wherein the processor performs decryption of the function concealed inner product functional encryption and the multi-input function concealed inner product functional encryption using the generated secret key and the n pieces of ciphertext to decrypt the n pieces of ciphertext.

6. A method for performing encryption and decryption using functional encryption using a quadratic function having n (where n is a predetermined integer of 2 or more) arguments, the method comprising:
generating a master secret key of the functional encryption using a master secret key of function concealed inner product functional encryption composed of pairing calculation and a master secret key of multi-input function concealed inner product functional encryption obtained by extending the function concealed inner product functional encryption to multi-inputs;
generating n pieces of ciphertext obtained by encrypting n pieces of data using the master secret key of the function concealed inner product functional encryption, the master secret key of the multi-input function concealed inner product functional encryption, and the master secret key of the functional encryption;
generating a secret key for decrypting the n pieces of ciphertext using data representing the quadratic function and the secret key of the multi-input function concealed inner product functional encryption; and
decrypting the n pieces of ciphertext using the generated secret key to generate a value of the quadratic function for the n pieces of data.

7. A non-transitory computer-readable recording medium having stored therein a program for causing a computer to perform the method according to claim 6.
